(19) United States
(12) Patent Application Publication
(10) Pub. No.: US 2020/0364829 A1
(43) Pub. Date: Nov. 19, 2020

(54) ELECTRONIC DEVICE AND METHOD FOR CONTROLLING THEREOF

(71) Applicant: SAMSUNG ELECTRONICS CO., LTD., Suwon-si (KR)

(72) Inventors: Iljun AHN, Suwon-si (KR); Yongsup PARK, Suwon-si (KR); Jaeyeon PARK, Suwon-si (KR)

(73) Assignee: SAMSUNG ELECTRONICS CO., LTD., Suwon-si (KR)

(21) Appl. No.: 16/859,146

(22) Filed: Apr. 27, 2020

(30) Foreign Application Priority Data
May 16, 2019 (KR) 10-2019-0057701

(51) Int. Cl. G06T 3/40; G06K 9/62; G06N 3/08

(52) U.S. Cl. CPC G06T 3/4046; G06K 9/6257; G06N 3/08; G06K 9/6262; G06K 9/6232

(57) ABSTRACT

Provided is an electronic device and a controlling method thereof. The electronic device includes a memory for storing at least one instruction, and a processor configured to execute the at least one instruction, in which the processor is configured to execute a convolution operation on an input image and obtain intermediate feature data relating to the image. The intermediate feature data is convolved with first kernels in a channel direction to obtain first data. The first data is then convolved with a second kernel in a spatial direction to obtain second data. Values of one or more weights included in the first kernels and the second kernel are set based on the second data, and values of weights may be adjusted based on positions of the weights.

### CROSS-REFERENCE TO RELATED APPLICATIONS

This application claims priority from Korean Patent Application No. 10-2019-0057701, filed in the Korean Intellectual Property Office on May 16, 2019, the disclosure of which is incorporated herein by reference.

### BACKGROUND OF THE INVENTION

### 1. Field

The disclosure relates to an electronic device and a method for controlling thereof, more particularly, relates to an electronic device which obtains a checkerboard-artifact-free image by executing convolution operations on feature data relating to an image with a plurality of kernels, and a method for controlling thereof.

### 2. Description of the Related Art

In recent years, the artificial intelligence system is applied in various fields. Unlike a smart system of executing various functions based on rules applied in advance, the artificial intelligence system is a system in that a machine trains itself, determines, and becomes smart. Accordingly, as the artificial intelligence system is used, a recognition rate is improved and preferences of a user can be more accurately understood, and thus, the existing smart system is gradually being replaced with the artificial intelligence system. The neural network is a representative technology of such an artificial intelligence system.

The neural network is a learning algorithm obtained by modelling features of biological neurons by mathematical expression. The neural network may generate mapping between input data and output data through the above learning algorithm, and the ability to generate the mapping may be learning ability of the neural network. A convolution neural network in the neural network is mainly used for analyzing a visual image.

In the convolution neural network or the like, it is necessary to execute deconvolution operation (or, processing) in order to generate an output image having a size larger than a size of an input image by enlarging the input image. However, when executing the deconvolution operation, in a case where a size value of the kernel is not divided by a size value of a stride applied to the deconvolution operation, a degree of overlapping of the kernel may be different at each position of the output image. When the degree of overlapping of the kernel becomes different at each position of the output image, artifacts may be evenly generated in the image in a shape of a checkerboard.

In addition, there was a problem that a processing amount of the existing deconvolution operation occupies a considerable part of the entire processing amount of the networks.

### SUMMARY OF THE INVENTION

Provided herein is an electronic device including: a memory for storing at least one instruction; and a processor configured to execute the at least one instruction, wherein the processor is configured to execute the at least one instruction to: execute a first convolution operation on an input image and obtain, as a result of the first convolution operation, intermediate feature data, obtain first data by executing a second convolution operation on the intermediate feature data with a plurality of first kernels in a channel direction, wherein the plurality of first kernels include first weights, obtain second data by executing a third convolution operation on the first data with a second kernel in a spatial direction, wherein the second kernel includes second weights, set, based on the second data, first values of the first weights or set second values of the second weights, adjust the first values of the first weights based on first positions of the first weights, and adjust the second values of the second weights based on second positions of the second weights.

In some embodiments of the electronic device, one of a height and a width of the plurality of first kernels has a first parameter of 1 and another one of the height and width has a second parameter of a predetermined integer value other than 1, wherein the processor is further configured to: normalize the first values of the first weights based on the first positions of the first weights in the plurality of first kernels, and normalize the second values of the second weights based on the second positions of the second weights in the second kernel.

In some embodiments of the electronic device, the processor is further configured to adjust the first values of the first weights to have identical sums in each first kernel of the plurality of first kernels.

In some embodiments of the electronic device, the processor is further configured to adjust the second values of the second weights by applying a reliability map, including a weight function, to the second kernel.

In some embodiments of the electronic device, the weight function includes a function with values gradually changing from a center of the reliability map.

In some embodiments of the electronic device, the processor is further configured to: decompose the second weights of the second kernel into a plurality of groups, and normalize each group of the plurality of groups based on positions of the second weights in the second kernel.

In some embodiments of the electronic device, the processor is further configured to identify a number of the plurality of groups and numbers of weights included in each group of the plurality of groups based on parameter values of the second kernel and a size of a stride applied by the third convolution operation.

In some embodiments of the electronic device, the processor is further configured to, for a first group of the plurality of groups, adjust the second values of the second weights to have uniform sums of the second weights included in the first group of the plurality of groups.

In some embodiments of the electronic device, the processor is further configured to: obtain the second data by executing the third convolution operation on the first data using the plurality of groups, and obtain an output image by rearranging the second data.

In some embodiments, the electronic device also includes a display, and the processor is further configured to control the display to display the output image, wherein the output image has a first size larger than a second size of the input image.

Also provided herein is a method for controlling an electronic device, the method including: executing a first convolution operation on an input image and obtaining, as a result of the first convolution operation, intermediate feature data; obtaining first data by executing a second convolution operation on the intermediate feature data with a plurality of first kernels in a channel direction, wherein the plurality of first kernels include first weights; obtaining second data by executing a third convolution operation on the first data with a second kernel in a spatial direction, wherein the second kernel includes second weights; setting, based on the second data, first values of the first weights or second values of the second weights; adjusting the first values of the first weights based on first positions of the first weights; and adjusting the second values of the second weights based on second positions of the second weights.

According to an embodiment of the disclosure, there is provided a memory for storing at least one instruction, and a processor configured to execute the at least one instruction, in which the processor is configured to execute convolution operation on an input image and obtain intermediate feature data relating to the image, obtain first data by executing convolution operation on the intermediate feature data with first kernels in a channel direction, and obtain second data by executing convolution operation on the obtained first data with a second kernel in a spatial direction, set values of one or more weights included in the first kernel and the second kernel based on the obtained second data, and adjust the set values of weights based on positions of the weights.

According to another embodiment of the disclosure, there is provided a method for controlling an electronic device, the method including executing convolution operation on an input image and obtaining intermediate feature data relating to the image, obtaining first data by executing convolution operation on the intermediate feature data with first kernels in a channel direction, and obtaining second data by executing convolution operation on the obtained first data with a second kernel in a spatial direction, setting values of one or more weights included in the first kernel and the second kernel based on the obtained second data, and adjusting the set values of weights based on positions of the weights.

### BRIEF DESCRIPTION OF THE DRAWINGS

FIG. 1A is a view for describing a process of obtaining second data by executing convolution operation on an input image according to an embodiment,

FIG. 1B is a view for describing a process of obtaining second data by executing convolution operation on an input image according to an embodiment,

FIG. 1C is a view for describing a process of obtaining second data by executing convolution operation on an input image according to an embodiment,

FIG. 2A is a block diagram simply showing a configuration of an electronic device according to an embodiment,

FIG. 2B is a block diagram specifically showing the configuration of the electronic device according to an embodiment,

FIG. 3 is a view for describing a process of executing deconvolution operation according to an embodiment,

FIG. 4 is a view for describing a process of executing convolution operation on intermediate feature data with first kernels in a channel direction according to an embodiment,

FIG. 5 is a view for describing a process of adjusting values of weights included in a second kernel according to an embodiment,

FIG. 6 is a view for describing a process of decomposing weights included in a second kernel into a plurality of groups according to an embodiment,

FIG. 7 is a view showing a checkerboard-artifact-generated image and a checkerboard-artifact-free image according to an embodiment, and

FIG. 8 is a flowchart for describing a method for controlling an electronic device according to an embodiment.

### DETAILED DESCRIPTION

The disclosure has been made for solving the above-mentioned problems, and an object of the disclosure is to provide an electronic device which executes convolution operation on data relating to an image with a plurality of kernels, and adjusts values of weights included in each kernel based on the executed result values, and a method for controlling thereof.

Hereinafter, various embodiments of the disclosure will be described with reference to the accompanying drawings. It should be noted that the technologies disclosed in this disclosure are not for limiting the scope of the disclosure to a specific embodiment, but they should be interpreted to include all modifications, equivalents or alternatives of the embodiments of the disclosure. In relation to explanation of the drawings, similar drawing reference numerals may be used for similar elements.

In the disclosure, the terms such as “consist of”, “may consist of”, “comprise”, or “may comprise” represents a presence of features (e.g., components such as numbers, functions, operations, or parts) and does not preclude a presence of additional features.

In the disclosure, expressions such as “A or B”, “at least one of A [and/or] B,”, or “one or more of A [and/or] B,” include all possible combinations of the listed items. For example, “A or B”, “at least one of A and B,”, or “at least one of A or B” includes any of (1) at least one A, (2) at least one B, or (3) at least one A and at least one B.

The expressions “first,” “second” and the like used in the disclosure may denote various elements, regardless of order and/or importance, and may be used to distinguish one element from another, and does not limit the elements.

If it is described that a certain element (e.g., first element) is “operatively or communicatively coupled with/to” or is “connected to” another element (e.g., second element), it should be understood that the certain element may be connected to the other element directly or through still another element (e.g., third element). On the other hand, if it is described that a certain element (e.g., first element) is “directly coupled to” or “directly connected to” another element (e.g., second element), it may be understood that there is no element (e.g., third element) between the certain element and another element.

Also, the expression “configured to” used in the disclosure may be interchangeably used with other expressions such as “suitable for,” “having the capacity to,” “designed to,” “adapted to,” “made to,” and “capable of,” depending on cases. Meanwhile, the expression “configured to” does not necessarily mean that a device is “specifically designed to” in terms of hardware. Instead, under some circumstances, the expression “a device configured to” may mean that the device “is capable of” performing an operation together with another device or component. For example, the phrase “a unit or processor configured (or set) to perform A, B, and C” may mean a dedicated processor (e.g., an embedded processor) for performing the corresponding operations, or a generic-purpose processor (e.g., a CPU or an application processor) that can perform the operations by executing one or more software programs stored in a memory device.

An electronic apparatus according to various embodiments of the disclosure may include at least one of, for example, a smartphone, a tablet PC, a mobile phone, an e-book reader, a desktop PC, a laptop PC, a netbook computer, a workstation, a server, a PDA, a portable multimedia player (PMP), a medical device, a camera, or a wearable device. In the disclosure, a term “user” may refer to a person using an electronic device or a device (e.g., an artificial intelligence electronic device) using an electronic device.

Hereinafter, the disclosure will be described in detail with reference to the drawings.

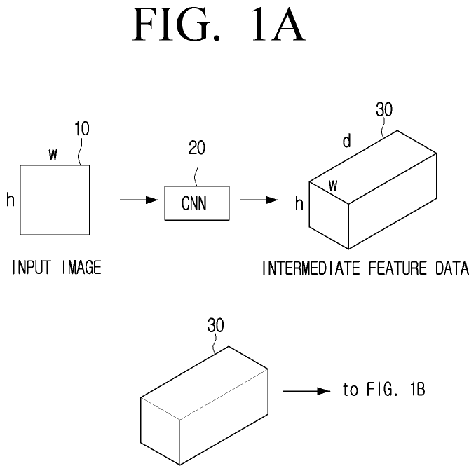

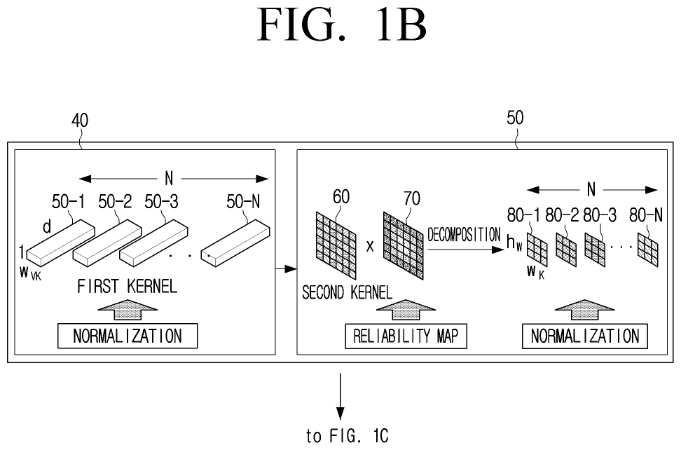

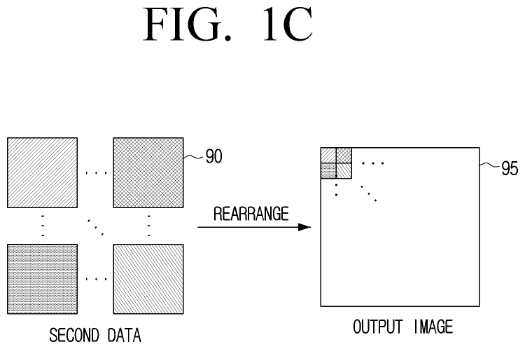

FIGS. 1A, 1B, and 1C are views for describing a process of obtaining second data by executing convolution operation on an input image according to an embodiment of the disclosure. As shown in FIG. 1A, an image 10 having parameters of a height of h and a width of w may be input to the electronic device 100. The electronic device 100 may input the input image 10 to a convolution neural network (CNN), extract features of the input image 10, and obtain intermediate feature data 30 relating to the image based on the extracted features. The intermediate feature data 30 may be a feature map obtained based on the extracted features of the input image 10 or in a form of a vector or a matrix, but this is merely an embodiment. As shown in FIG. 1A, the intermediate feature data 30 may have parameters of a height of h and a width of w in the same manner as in the input image 10, and may have a channel parameter of d.

As shown in FIG. 1B, the electronic device 100 may obtain first data by executing convolution operation 40 on the intermediate feature data 30 with first kernels 50-1, 50-2, 50-3, . . . , and 50-N in a channel direction, and obtain second data 90 by executing convolution operation 50 on the obtained first data with a second kernel 60 in a spatial direction. The channel direction may correspond to input depth. In some embodiments, for example, one channel may correspond to one color (or, pattern). One of a height and a width of each of the first kernels 50-1, 50-2, . . . , and 50-N in the channel direction may have a parameter of 1, the other one thereof may have a parameter of a predetermined integer value other than 1, and a channel parameter which is d may be identical to the channel parameter of the intermediate feature data 30. With the second kernel 60 in the spatial direction, the convolution may be executed in a spatial direction for each channel of the first data.

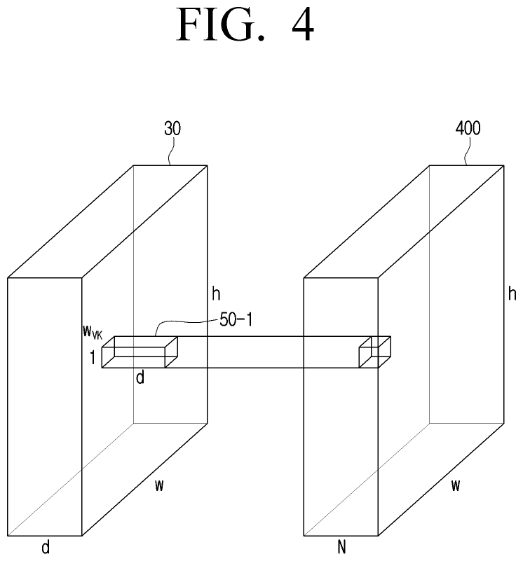

According to an embodiment of the disclosure, FIG. 1B shows the first kernels 50-1, 50-2, . . . , and 50-N in each of which the height has a parameter of 1, the width has a parameter of a predetermined value W_{VK} other than 1, and the channel parameter is identical to that of the intermediate feature data 30. Thus the first kernels operate over depth d. As shown in FIG. 1B, the operation executed between the first kernels 50-1, 50-2, . . . , and 50-N in the channel direction and the intermediate feature data 30 may be referred to as vertical-wise convolution. In another embodiment, convolution executed with a kernel in which a height has a parameter of W_{VK} other than 1, a width has a parameter of a predetermined 1, and a channel parameter is identical to that of the intermediate feature data 30 may be referred to as horizontal-wise convolution. The convolution operation between the first kernels 50-1, 50-2, . . . , and 50-N and the intermediate feature data 30 will be described in detail with reference to FIG. 4.

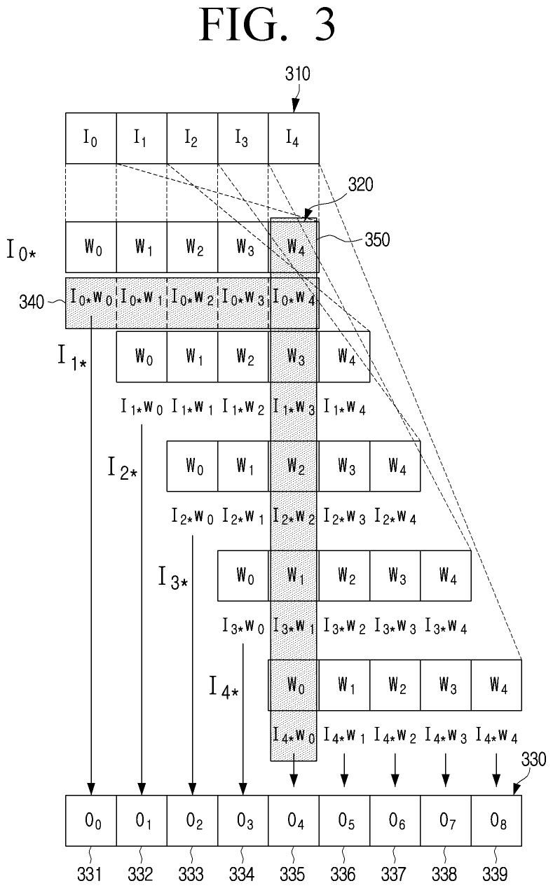

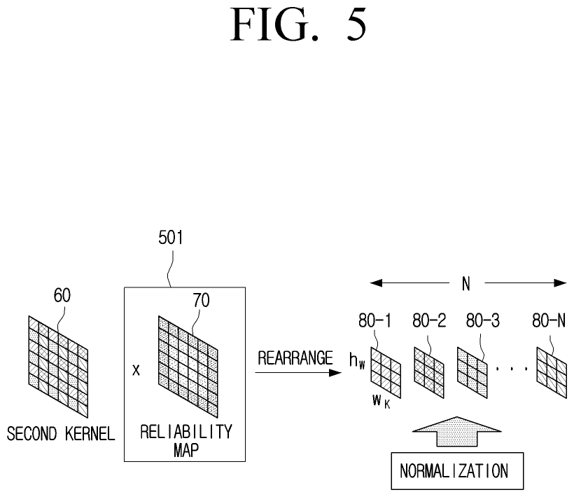

The electronic device 100 may normalize the first kernels 50-1, 50-2, . . . , and 50-N based on positions of weights included in the first kernels 50-1, 50-2, . . . , and 50-N. Specifically, the electronic device 100 may adjust values of weights to have identical sums of weights included in each of the first kernels 50-1, 50-2, . . . , and 50-N. In general, in a case where deconvolution operation is executed between the input data and the kernels, a rapid change of values of the weights included in the kernels may cause checkerboard artifacts in output data. For example, deconvolution may be used to upscale an image or to reduce a blur. In particular, when adjacent weight values rapidly change in a high frequency region (for example, region having a large pixel value) of the input data, the checkerboard artifacts may be generated in a region of the output data corresponding to the high frequency region. Accordingly, in order to prevent the generation of the checkerboard artifacts, the electronic device 100 may normalize the first kernels 50-1, 50-2, . . . , and 50-N to have identical sums of weights included in the first kernels 50-1, 50-2, . . . , and 50-N. The reason for the generation of the checkerboard artifacts and the process of the normalization will be described in detail with reference to FIG. 3 and FIG. 5.

The electronic device 100 may adjust values of weights included in the second kernel 60 by applying a reliability map 70 including a weight function to the second kernel 60. The weight function may include a function in which values gradually change from the center of the reliability map 70. In an embodiment, the weight function may include at least one of a linear function, a Gaussian function, a Laplacian function, and a spline function, but this is merely an embodiment and the weight function may include various functions. In a case where the reliability map 70 is applied to the second kernel 60, the values of weights included in the second kernel 60 do not rapidly change, and therefore the generation of the checkerboard artifacts in the second data 90 may be prevented. Particularly, the generation of the checkerboard artifacts in a region of the second data 90 corresponding to a high frequency region (for example, region having a large pixel value) of the input data may be prevented.

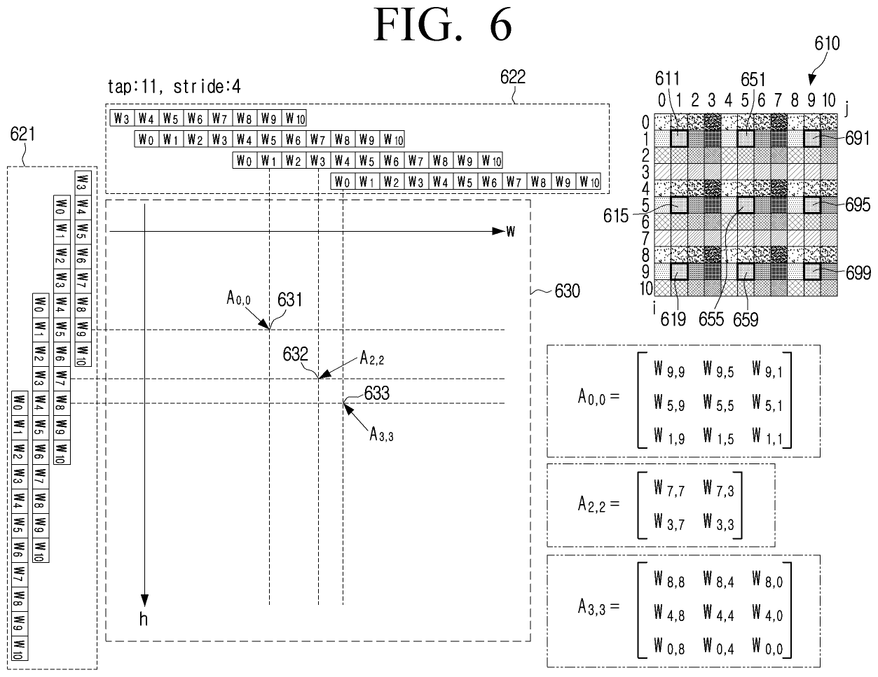

In addition, the electronic device 100 may decompose the weights of the second kernel 60 into a plurality of groups 80-1, 80-2, 80-3, . . . , and 80-N and normalize each of the plurality of decomposed groups 80-1, 80-2, . . . , and 80-N based on the positions of the weights included in the second kernel 60. Decomposition of a filter function such as a kernel may also be referred to as factorization of a convolution kernel. Specifically, the electronic device 100 may determine the number of plurality of groups 80-1, 80-2, . . . , and 80-N and the number of weights included in the plurality of groups 80-1, 80-2, . . . , and 80-N based on parameter values of the second kernel 60 and a size of a stride applied to the convolution operation. In addition, the electronic device 100 may adjust values of weights to have uniform sums of weights included in each of the plurality of groups 80-1, 80-2, . . . , and 80-N. The process of decomposing the second kernel 60 and setting sums of weights to be uniform will be described in detail with reference to FIG. 6.

The electronic device 100 may obtain the second data 90 by executing the convolution operation on the plurality of groups 80-1, 80-2, . . . , and 80-N in a spatial direction with the first data, and obtain an output image 95 by rearranging the obtained second data 90. The convolution operation executed regarding the plurality of groups 80-1, 80-2, . . . , and 80-N in a spatial direction for each channel of the first data may be referred to as depth-wise convolution. The process of executing the depth-wise convolution will be described in detail with reference to FIGS. 4 and 5.

In addition, the electronic device 100 may obtain a checkerboard-artifact-free output image 95 having a size larger than a size of the input image 10 and display the obtained output image 95 on a display 130.

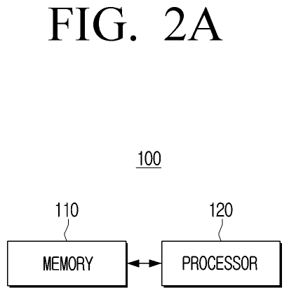

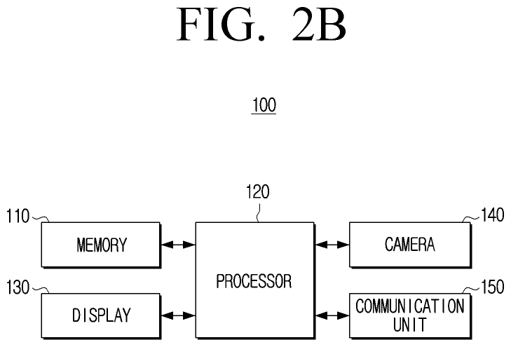

FIG. 2 simply shows a configuration of the electronic device 100 according to an embodiment of the disclosure. As shown in FIG. 2, the electronic device 100 may include a memory 110 and a processor 120. However, there is no limitation to the above-mentioned configuration and some configurations may be added or omitted depending on a type of the electronic device 100.

The memory 110 may store an instruction or data relating to at least one of other elements of the electronic device 100. Particularly, the memory 110 may be implemented as a non-volatile memory, a volatile memory, a flash memory, a hard disk drive (HDD), or a solid-state drive (SSD). The memory 120 may be accessed by the processor 120 and reading, recording, editing, deleting, or updating of the data by the processor 120 may be executed. A term “memory” in the disclosure may include the memory 110, a ROM (not shown) or a RAM (not shown) in the processor 120, or a memory card (not shown) (for example, a micro SD card or memory stick) mounted on the electronic device 100. In addition, the memory 110 may store programs or data for configuring various screens displayed on a display region of the display 130.

Further, the memory 110 may store programs for executing an artificial intelligence agent. The artificial intelligence agent is a customized program for providing various services to the electronic device 100. In addition, the memory 110 may store an artificial intelligence model trained for extracting data of the input image.

The processor 120 may be electrically connected to the memory 110 and control general operations and functions of the electronic device 100 by executing at least one instruction.

Particularly, the processor 120 may execute the convolution operation relating to the input image and obtain intermediate feature data relating to the image. In an embodiment of the disclosure, the processor 120 may input an image to a convolution neural network (CNN) and extract intermediate feature data or a feature map. The extraction of feature data of the input image through the CNN is a well-known technology and thus will be omitted.

The processor 120 may obtain first data by executing the convolution operation (vertical-wise convolution or horizontal-wise convolution) on the obtained intermediate feature data relating to the image with the first kernels in the channel direction, and obtain second data by executing the convolution operation (depth-wise convolution) on the obtained first data with the second kernel in the spatial direction.

In addition, the processor 120 may set values of one or more weights included in the first kernels and the second kernel based on the obtained second data. In an embodiment, the processor 120 may set weight values included in the first kernels and the second kernel using a learning algorithm including error back-propagation or gradient descent. Specifically, the processor 120 may obtain an output image by rearranging the obtained second data, and compare and analyze the output image and an image obtained by enlarging the input image. The processor 120 may set weight values of the first kernels and the second kernel based on the analyzed result.

The processor 120 may normalize each of the first kernels based on positions of the weights included in the first kernels. Specifically, the numbers of weights applied to each of pixels included in the first data obtained by executing the convolution operation with the first kernel in the channel direction may be different from each other, and when the weights applied to one pixel are not normalized, sums of the weights applied to each of the pixels of the first data may not be uniform. Accordingly, in an embodiment, the processor 120 may adjust the values of the weights to have uniform sums of weights included in each of the first kernels.

In addition, the processor 120 may adjust values of weights included in the second kernel by applying a reliability map including a weight function to the second kernel. Specifically, the processor 120 may adjust the values of the weights included in the second kernel by multiplying the second kernel by the reliability map. The weight function included in the reliability map may include at least one of a linear function, a Gaussian function, a Laplacian function, and a spline function, but this is merely an embodiment and the weight function may include various functions.

The processor 120 may decompose the weights of the second kernel into a plurality of groups and normalize each of the plurality of decomposed groups based on the positions of the weights included in the second kernel. Specifically, the processor 120 may determine the number of the plurality of groups and the number of weights included in the plurality of groups based on the parameter values (or size) of the second kernel and the size of the stride applied to the convolution operation. In addition, the processor 120 may adjust values of the weights to have uniform sums of the weights included in the plurality of decomposed groups.

Further, the processor 120 may obtain second data by executing the convolution operation on the plurality of groups in the spatial direction with the first data, and obtain an output image by obtaining the second data. A size of the output image may be larger than the size of the input image and the checkerboard artifacts may not be generated. The processor 120 may control the display 130 to display the output image.

In describing the disclosure, the processor 120 may be constituted with one or a plurality of processors. The function related to the artificial intelligence according to the disclosure is operated by the memory 110 and the processor 120. The one or the plurality of processors 120 performs control to process the input data according to a predefined action rule stored in the memory 110 or an artificial intelligence model. The predefined action rule or the artificial intelligence model is formed through training. The forming through training herein means forming a predefined action rule or an artificial intelligence model having a desired feature by applying a training algorithm to a plurality of pieces of learning data. Such training may be performed in a device demonstrating artificial intelligence according to the disclosure or performed by a separate server or system.

A function related to the artificial intelligence according to the disclosure is operated by a processor and a memory. The processor may be constituted with one or a plurality of processors. The one or the plurality of processors may be a general-purpose processor such as a CPU, AP, or a digital signal processor (DSP), a graphic dedicated processor such as a GPU or a VPU, or an artificial intelligence processor such as a NPU. The one or the plurality of processors performs control to process the input data according to a predefined action rule stored in the memory or the artificial intelligence model. In addition, if the one or the plurality of processors are artificial intelligence dedicated processors, the artificial intelligence dedicated processor may be designed to have a hardware structure specialized in processing of a specific artificial intelligence model.

The predefined action rule or the artificial intelligence model is formed through training. The forming through training herein means forming a predefined action rule or an artificial intelligence model set to execute a desired feature (or object) by training a basic artificial intelligence model by using a plurality of pieces of learning data by the training algorithm. Such training may be performed in a device demonstrating artificial intelligence according to the disclosure or performed by a separate server or system. Examples of the learning algorithm include a supervised learning, unsupervised learning, semi-supervised learning, or reinforcement learning, but is not limited to these examples.

The artificial intelligence model may be constituted with a plurality of neural network layers. The plurality of neural network layers have a plurality of weight values, respectively, and execute neural network processing through a processing result of a previous layer and processing between the plurality of weights. The plurality of weights of the plurality of neural network layers may be optimized by the training result of the artificial intelligence model. For example, the plurality of weights may be updated to reduce or to minimize a loss value or a cost value obtained by the artificial intelligence model during the training process. The artificial neural network may include deep neural network (DNN), and, for example, include a convolutional neural network (CNN), deep neural network (DNN), recurrent neural network (RNN), restricted Boltzmann machine (RBM), deep belief network (DBN), bidirectional recurrent deep neural network (BRDNN), or deep Q-network, but there is no limitation to these examples.

FIG. 2B is a block diagram specifically showing the configuration of the electronic device 100 according to an embodiment of the disclosure. As shown in FIG. 2B, the electronic device 100 may include the memory 110, the processor 120, the display 130, a camera 140, and a communication unit 150. The communication unit 150 may include a network interface card for communication with a network and/or a radio transceiver for wireless communication. The memory 110 and the processor 120 have been described in FIG. 2A and therefore the overlapped description will be omitted.

The display 130 may display various pieces of information under the control of the processor 120. Particularly, the processor 120 may control the display 130 to display output data obtained by rearranging second data.

The display 130 may be implemented as a touch screen with a touch panel. However, there is no limitation to the above implementation and the display 130 may be differently implemented depending on a type of the electronic device 100.

The camera 140 may image a user. Particularly, a captured image of a user may be included in a UI displayed when a user is recognized. The camera 140 may be provided on at least one of a front side or a rear side of the electronic device 100. The camera 140 may be provided in the electronic device 100, but this is merely an embodiment, and the camera 140 may also be provided outside of the electronic device 100 and connected to the electronic device 100 in a wired or wireless manner.

The communication 150 may execute the communication with an external device through various communication methods. The communication connection between the communication unit 150 and the external device may include communication via a third device (for example, a relay device, a hub, an access point, a server, or a gateway).

The communication unit 160 may include various communication modules for executing the communication with an external device. As an example, the communication unit 150 may include a wireless communication module, and for example, may include a cellular communication module using at least one of LTE, LTE Advance (LTE-A), code division multiple access (CDMA), wideband CDMA (WCDMA), universal mobile telecommunications system (UMTS), Wireless Broadband (WiBro), or Global System for Mobile Communications (GSM). In another example, the wireless communication module, for example, may include at least one of WiFi (wireless fidelity), Bluetooth, Bluetooth low energy (BLE), Zigbee, near field communication (NFC), magnetic secure transmission, a radio frequency (RF), or body area network (BAN). In addition, the communication unit 160 may include a wired communication module and for example, may include at least one of a universal serial bus (USB), a high definition multimedia interface (HDMI), recommended standard 232 (RS-232), power line communication, or plain old telephone service (POTS). The network, through which the wireless communication or the wired communication is performed, may include at least one of a telecommunication network, for example, a computer network (e.g., LAN or WAN), the Internet, or a telephone network.

The processor 120 may include or be defined as one or more of a central processing unit (CPU), a microcontroller unit (MCU), a microprocessing unit (MPU), a controller, an application processor (AP), a communication processor (CP), and an ARM processor. In addition, the processor 120 may be implemented as a system on chip (SoC) or a large scale integration (LSI) with embedded processing algorithms or may be implemented in a form of a field programmable gate array (FPGA). The processor 120 may execute various functions by executing computer executable instructions stored in the memory 110. In addition, the processor 120 may include at least one of a graphics-processing unit (GPU), a neural processing unit (NPU), and a visual processing unit (VPU) which are separate AI-dedicated processors, in order to execute the artificial intelligence functions.

FIG. 3 is a view for describing a process of executing deconvolution operation and the reason for the generation of the checkerboard artifacts. That is, FIG. 3 is a view for describing that the checkerboard artifacts may be generated, in a case where the deconvolution operation is immediately executed for resizing of the intermediate feature data relating to the image obtained from the input image.

In FIG. 3, for convenience of description, input data 310, a kernel 320, and output data 330 are assumed to be in a one-dimensional manner. In addition, it is assumed that a size of the input data 310 is 5, a size of the kernel 320 applied to the input data 310 is 5, a size of the stride is 1, and a size of the output data 330 is 9.

Referring to FIG. 3, each of values I₀*W₀, I₀*W₁, I₀*W₂, I₀*W₃, and I₀*W₄ obtained by multiplying a pixel value I₀ of the input data 310 by weight values W₀, W₁, W₂, W₃, and W₄ included in the kernel may be mapped onto each of first to fifth pixels 331, 332, 333, 334, and 335 of the output data 330.

In addition, each of values I₁*W₀, I₁*W₁, W₂, I₁*W₃, and I₁*W₄ obtained by multiplying a pixel value I₁ of the input data 310 by the weight values W₀, W₁, W₂, W₃, and W₄ included in the kernel 320 may be mapped onto each of second to sixth pixels 332, 333, 334, 335, and 336 of the output data 330.

In addition, each of values I₂*W₀, I₂*W₁, I₂*W₂, I₂*W₃, and I₂*W₄ obtained by multiplying a pixel value I₂ of the input data 310 by the weight values W₀, W₁, W₂, W₃, and W₄ included in the kernel 320 may be mapped onto each of third to seventh pixels 333, 334, 335, 336, and 337 of the output data 330.

In addition, each of values I₃*W₀, I₃*W₁, I₃*W₂, I₃*W₃, and I₃*W₄ obtained by multiplying a pixel value I₃ of the input data 310 by the weight values W₀, W₁, W₂, W₃, and W₄ included in the kernel 320 may be mapped onto each of fourth to eighth pixels 334, 335, 336, 337, and 338 of the output data 330.

In addition, each of values I₄*W₀, I₄*W₁, I₄*W₂, I₄*W₃, and I₄*W₄ obtained by multiplying a pixel value I₄ of the input data by the weight values W₀, W₁, W₂, W₃, and W₄ included in the kernel 320 may be mapped onto each of fifth to ninth pixels 335, 336, 337, 338, and 339 of the output data 330.

Accordingly, a value O₀ of the first pixel 331 of the output data 330 is I₀*W₀, a value O₁ of the second pixel 332 is I₀*W₁+I₁*W₀, a value O₂ of the third pixel 333 is I₀*W₂+I₁*W₁+I₂*W₀, a value O₃ of the fourth pixel 334 is I₀*W₃+W₂+I₂*W₁+I₃*W₀, and a value O₄ of the fifth pixel 335 is I₀*W₄+I₁*W₃+I₂*W₂+I₃*W₁+I₄*W₀.

From a viewpoint of the input data 310, each of the plurality of weight values (for example, W₀, W₁, W₂, W₃, and W₄) is multiplied by one pixel value (for example, I₀) of the input data 310, and values 340 obtained by multiplying the plurality of weights are mapped onto the plurality of pixels (for example, 331 to 335) of the output data, and accordingly, the deconvolution operation corresponds to a scatter operation.

When weight values (for example, W₀, W₁, W₂, W₃, and W₄) included in the kernel rapidly change, the checkerboard artifacts may be generated in the output data. Particularly, when adjacent weight values rapidly change in a high frequency region (region having a large pixel value) of the input data 310, the checkerboard artifacts may be generated in a region of the output data corresponding to the high frequency region. Meanwhile, from a viewpoint of the output data 330, one pixel value (for example, 04) of the output data 330 is determined by values obtained by adding values 350 obtained by multiplying each of the plurality of pixel values (for example, I₀, I₁, I₂, I₃, and I₄) of the input data 310 by each of the plurality of weight values (for example, W₀, W₁, W₂, W₃, and W₄), and accordingly, the deconvolution operation corresponds to a gather operation.

The weights applied to each of the pixels included in the output data 330 are not identical. For example, referring to FIG. 3, one weight W₀ is applied to the first pixel 331, two weights W₀ and W₁ are applied to the second pixel 332, three weights W₀, W₁, and W₂ are applied to the third pixel 333, four weights W₀, W₁, W₂, and W₃ are applied to the fourth pixel 334, and five weights W₀, W₁, W₂, W₃, and W₄ are applied to the fifth pixel 335. As described above, when the numbers of weights applied to each of the pixels included in the output data 330 are different from each other and the weights applied to one pixel are not normalized, the sums of the weights applied to each of the pixels of the output data 330 may not be uniform.

For example, when the sum of the four weights W₀, W₁, W₂, and W₃ applied to the fourth pixel 334 and the sum of the five weights W₀, W₁, W₂, W₃, and W₄ applied to the fifth pixel are not uniform, the checkerboard artifacts may be generated in the output data when executing the deconvolution operation. In some situations, the number of applicable weights depends on position of the pixel being obtained (see 331 . . . 339 in FIG. 3). By adjusting the sum of the weights depending on which pixel is being obtained, variations in the output image caused by the filter weights themselves can be reduced. When image processing is done on smaller areas within an image, the number of weights applicable to a pixel may change at the edge of the smaller area. Repetition of the event of variable number of weights across the processing of an image can lead to the checkerboard pattern.

FIG. 4 is a view for describing a process of executing the convolution operation on the intermediate feature data 30 with the first kernel in the channel direction according to an embodiment of the disclosure. As shown in FIG. 4, the electronic device 100 may execute the convolution operation on the intermediate feature data 30 and the first kernel 50-1 in the channel direction. The channel parameter of the first kernel 50-1 in the channel direction may be identical to the channel parameter of the intermediate feature data 30 as d. Regarding parameters of the first kernel 50-1, one of a height and a width may have a parameter of 1, and the other one thereof may have a parameter of a predetermined integer value other than 1. FIG. 4 shows the first kernel 50-1 in which the height has a parameter of 1 and the width has a parameter of a predetermined integer value other than 1, but this is merely an embodiment, and the first kernel may have parameters in which the width has a parameter of 1 and the height has a parameter of a predetermined integer value other than 1.

FIG. 4 shows only one first kernel 50-1, but the electronic device 100 may obtain first data 400 by executing the convolution operation on the intermediate feature data 30 with N pieces of first kernels. The electronic device 100 may compress the intermediate feature data 30 into one channel by executing the convolution operation with the first kernel in the channel direction. The channel parameter of the first data 400 may be N, as shown in FIG. 4, since the electronic device 100 executes the convolution operation with the N pieces of the first kernels.

All of the pixels included in the intermediate feature data 30 may include the identical pixel values (for example, 1). A value of each of the pixels included in the first data 400 may be expressed as the sum of weights applied to each pixel. In a case where the weights applied to one pixel are not normalized, the sums of weights applied to each of the pixels are not uniform and therefore, the first data 400 may include checkerboard artifacts having a certain pattern. Thus, the electronic device 100 may normalize the first kernel 50-1 based on the positions of the weights included in the first kernel 50-1. In an example, the electronic device 100 may adjust values of the weights to have uniform sums of the weights included in each of the first kernels. In addition, the electronic device 100 may adjust the weights so that the values of the pixels of the first data 400 are identical to the values (for example, 1) of the pixels of the intermediate feature data 30 and the sum of weights applied to each of the pixels of the first data 400 become 1.

FIG. 5 is a view for describing a process of adjusting values of weights included in the second kernel 60 according to an embodiment of the disclosure. As shown in FIG. 5, the electronic device 100 may apply (501) the reliability map 70 including a weight function to the second kernel 60. The electronic device 100 may decompose the weights of the second kernel 60 into a plurality of groups and normalize each of the plurality of decomposed groups based on the positions of the weights included in the second kernel 60.

The electronic device 100 may set values of one or more weights included in the second kernel 60 used in the convolution operation. At that time, the values of the weights included in the second kernel 60 may be set according to the learning and updating of the neural network including convolution layers, in which the convolution operation is executed, but there is no limitation thereto.

The electronic device 100 according to an embodiment of the disclosure may adjust values of one or more weights included in the second kernel 60 by applying (for example, executing multiplication) the reliability map 70 to the second kernel 60. The reliability map 70 according to an embodiment of the disclosure may include a weight function and the weight function may be a function making values decrease from the center of the reliability map 70. That is, the reliability is high when it is close to the center of the reliability map 70. The weight function may include at least one of a linear function, a Gaussian function, a Laplacian function, and a spline function, but this is merely an embodiment. The reliability map 70 shown in FIG. 5 may be a map representing a Gaussian function.

According to an embodiment of the disclosure, in a case where the reliability map 70 is applied to the second kernel 60, the values of one or more weights included in the second kernel 60 may not rapidly change. In a case where the values of the weights rapidly change, the checkerboard artifacts may be generated in the high frequency region of the second data obtained by executing the convolution with the second kernel 60. Therefore, the electronic device 100 may set the values of the weights not to rapidly change by applying (for example, executing multiplication) the reliability map 70 to the second kernel 60.

The electronic device 100 may decompose the weights included in the second kernel 60 into the plurality of groups 80-1, 80-2, . . . , and 80-N based on the positions in the second kernel 60. A method for decomposing the weights included in the second kernel 60 into the plurality of groups will be described in detail with reference to FIG. 6.

The electronic device 100 may normalize each of the plurality of decomposed groups 80-1, 80-2, . . . , and 80-N. In an example, the electronic device 100 may perform the normalization to have identical sums of the weights included in the first group 80-1 and the second group 80-2 (for example, to have identical sums as ‘1’). In a case where the sums of the weights included in each of the groups 80-1, 80-2, . . . , and 80-N are not uniform, the second data obtained by the convolution operation with the plurality of groups 80-1, 80-2, . . . , and 80-N may include the checkerboard artifacts.

The electronic device 100 may obtain second data by executing the convolution operation on the plurality of groups 80-1, 80-2, . . . , and 80-N in the spatial direction with the first data. The convolution operation executed between the first data and the plurality of groups 80-1, 80-2, . . . , and 80-N may be referred to as depth-wise convolution. In an embodiment, the electronic device 100 may execute the convolution operation on the first data with the first group 80-1 only in the spatial direction, not in the channel direction. As shown in FIG. 5, the second kernel 60 is decomposed into N pieces of groups, and accordingly, the electronic device 100 may obtain second data by executing the convolution operation on the N pieces of groups in the spatial direction with the first data.

The electronic device 100 may obtain a checkerboard-artifact-free output image having a size larger than a size of the input image by rearranging the obtained second data. In addition, the electronic device 100 may display the output image on the display 130.

As shown in FIGS. 4 and 5, in a case where the electronic device 100 executes the convolution on the intermediate feature data with the first kernel in the channel direction and the second kernel in the spatial direction, the processing amount may be significantly decreased, compared to a case of executing the existing deconvolution operation on the intermediate feature data at once.

A rate of the processing amount decreasing may be specifically confirmed through the following Mathematical Expression (1). In Mathematical Expression (1), an expression in the denominator is for calculating a processing amount when the deconvolution operation is executed on the intermediate feature data at once, and an expression in the numerator is for calculating a processing amount when the convolution operation is executed with the first kernel and the second kernel.

$$\frac{\begin{matrix}{w}_{VK} \times 1 \times d \times {N}^{2} \times h \times w + {h}_{K} \times \\ {w}_{K} \times h \times w \times {N}^{2}\end{matrix}}{{h}_{K} \times {w}_{K} \times d \times {N}^{2} \times h \times w} = \frac{{w}_{VK}}{{h}_{K} \times {w}_{K}} + \frac{1}{d} \qquad [ Mathematical Expression 1 ]$$

In a case where the channel parameter d of the intermediate feature data is 64, the width parameter of the first kernel is 3, and the height and width parameters of each of the decomposed groups of the second kernel are 3, a value of 0.349 is derived when substituting each value in Expression (1). That is, the processing amount of approximately 65% may be decreased when outputting the output image by executing the convolution operation according to an embodiment of the disclosure, compared to a case of executing the existing deconvolution operation.

FIG. 6 is a view for describing a process of decomposing weights included in a second kernel into a plurality of groups according to an embodiment of the disclosure. That is, FIG. 6 is a view for describing a process of determining the number of a plurality of groups and the number of weights included in the plurality of groups by the electronic device 100 based on parameter values (or size) of a second kernel and a size of a stride applied to the convolution operation.

In FIG. 6, a method for decomposing the weights included in a second kernel 610 into a plurality of groups, in a case where a size (tap) of the second kernel 610 is 11×11 and the size of the stride is 4, will be described. Coordinates 630 shown in FIG. 6 are coordinates representing second data, in which a horizontal coordinate w indicates a position in a horizontal direction of a pixel included in the second data and a vertical coordinate h indicates a position in a vertical direction of a pixel included in the second data.

Assuming that the second kernel 610 according to an embodiment is represented as a two-dimensional matrix (11×11 matrix), indexes shown in weights 622 shown in the upper portion of the coordinates 630 represent horizontal positions j of the weights in the second kernel 610. In addition, indexes shown in weights 621 shown in the left side of the coordinates represent vertical positions i of the weights in the kernel.

Further, the weights 621 and 622 shown in the upper portion and the left side of the coordinates are shown to correspond to positions of pixels, to which the weights are applied, by considering the size of the stride (for example, an interval of four pixels) and the positions of the pixels included in the second data.

For example, regarding the weights applied to the first pixel 631 included in the second data, the horizontal positions j are 1, 5, and 9 and the vertical positions i are 1, 5, and 9. When the horizontal positions and the vertical positions of the weights are combined, the weights applied to the first pixel 631 are W_{1,1} (611), W_{1,5} (615), W_{1,9} (619), W_{5,1} (651), W_{5,5} (655), W_{5,9} (659), W_{9,1} (691), W_{9,5} (695), and W_{9,9} (699) included in the second kernel 610.

In addition, regarding the weights applied to a second pixel 632 included in the second data, the horizontal positions j are 3 and 7 and the vertical positions i are 3 and 7. When the horizontal positions and the vertical positions of the weights are combined, the weights applied to the second pixel 632 are W_{3,3}, W_{3,7}, W_{7,3}, and W_{7,7} included in the second kernel 610.

In addition, regarding the weights applied to a third pixel 633 included in the second data, the horizontal positions j are 0, 4, and 8 and the vertical positions i are 0, 4, and 8. When the horizontal positions and the vertical positions of the weights are combined, the weights applied to the third pixel 633 are W_{0,0}, W_{0,4}, W_{0,8}, W_{4,0}, W_{4,4}, W_{4,4}, W_{8,0}, and W_{8,4} included in the second kernel 610.

That is, the electronic device 100 may decompose the weights applied to each of the pixels included in the second data into a plurality of groups. In an embodiment, the electronic device 100 may make a group of the nine weights applied to the first pixel 631 as a first group and the first group may be represented as a matrix A_{0,0} as shown in FIG. 6. In addition, the electronic device 100 may make a group of the four weights applied to the second pixel 632 as a second group and the second group may be represented as a matrix A_{2,2}. The electronic device 100 may make a group of the nine weights applied to the third pixel 633 as a third group and the third group may be represented as A_{3,3}.

Among the weights included in the second kernel 610 shown in FIG. 6, the weights shown with the same color (or, pattern) may represent weights included in the same group (applied to the same pixel).

In a case of representing the weights grouped as one group in one matrix, the size of the matrix (size (A_{i,j})) may be represented by Mathematical Expression 2 shown below.

$$Size ( {A}_{i , j} ) = [ M , N ] = [ \begin{matrix}floor ( \frac{( tap - 1 ) - ( c + i )}{s} ) + floor ( \frac{c + i}{s} ) + 1 , \\ floor ( \frac{( tap - 1 ) - ( c + i )}{2} ) + floor ( \frac{c + i}{s} ) + 1\end{matrix} ] \qquad [ Mathematical Expression 2 ]$$

In Mathematical Expression 2, floor represents rounding-down, s represents the size of the stride, and c may be represented by Mathematical Expression 3 shown below.

$$s \leq c = \frac{tap - 1}{2} \leq 2 \times s \qquad [ Mathematical Expression 3 ]$$

Referring to Mathematical Expressions 2 and 3, the number of the plurality of groups is determined based on the size (tap) of the kernel and the size (s) of the stride, and the number of weights included in each of the plurality of groups may be also determined based on the size (tap) of the kernel and the size (s) of the stride.

In addition, the indexes of components included in the matrix A may be represented by Mathematical Expression 4 shown below.

$$[ \begin{matrix}{W}_{{t}_{M , i} - 0 xs , {t}_{N , j} - 0 x s} & … & {W}_{{t}_{M , i} - 0 xs , {t}_{N , j} - ( N - 1 ) x s} \\ ⋮ & ⋱ & ⋮ \\ {W}_{{t}_{M , i} - ( M - 1 ) xs {t}_{N , j} - 0 x s} & … & {W}_{{t}_{M , i} - ( M - 1 ) xs {t}_{N , j} - ( N - 1 ) xs}\end{matrix} ] \qquad [ Mathematical Expression 4 ]$$

In Mathematical Expression 4, tM,i may be represented by Mathematical Expression 5 shown below and tN,j may be represented by Mathematical Expression 6.

t_{M,i}=(t+1)% s+(M−1)×s [Mathematical Expression 5]

t_{N,j}=(t+1)% s+(N−1)×s [Mathematical Expression 6]

In Mathematical Expressions 5 and 6, % represents the remainder. For example, (t+1)% s represents a remainder obtained by dividing (t+1) by s.

For example, in a case where the size (tap) of the kernel is 11 and the size (s) of the stride is 4, when performing the calculation by applying these to Mathematical Expressions 1 to 5, the size of the matrix A_{0,0} is 3×3 (M=3, N=3) and an index of a first element of the matrix A_{0,0} is W_{9,9}.

With respect to each of the matrices, the electronic device 100 according to an embodiment may normalize the sums of component values (weight values) included in each of the matrices. In an embodiment, the electronic device 100 may adjust weight values to have uniform sums of the weights included in each of the matrices (for example, to have the sums as ‘1’).

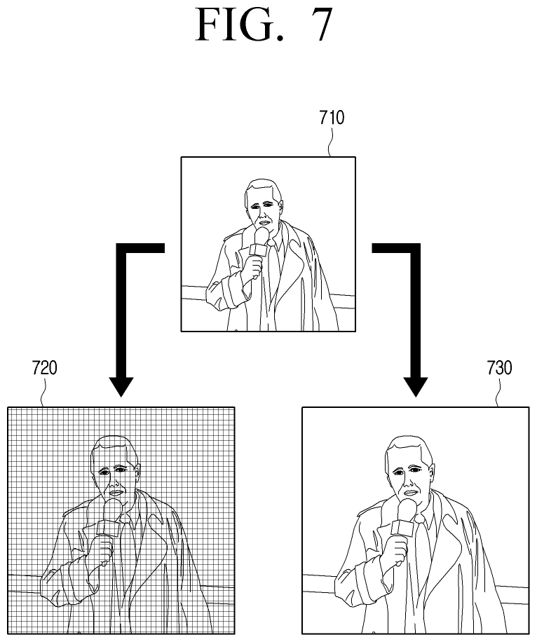

FIG. 7 is a view showing a checkerboard-artifact-generated image and a checkerboard-artifact-free image according to an embodiment of the disclosure. As shown in FIG. 7, the electronic device 100 may obtain intermediate feature data by inputting an input image 710 to the CNN, and obtain second data by executing the convolution on the intermediate feature data with the first kernel in the channel direction and executing the convolution on the executed result value with the second kernel in the spatial direction. The electronic device 100 may obtain an output image by rearranging the second data. In a case where the normalization is not executed for the first kernel and the reliability map is not applied to the second kernel and the normalization thereof is not executed, the electronic device 100 may obtain a checkerboard-artifact-generated output image 720. However, in a case where the normalization is executed for the first kernel and the reliability map is applied to the second kernel and the normalization thereof is executed, the electronic device 100 may obtain a checkerboard-artifact-free output image 730.

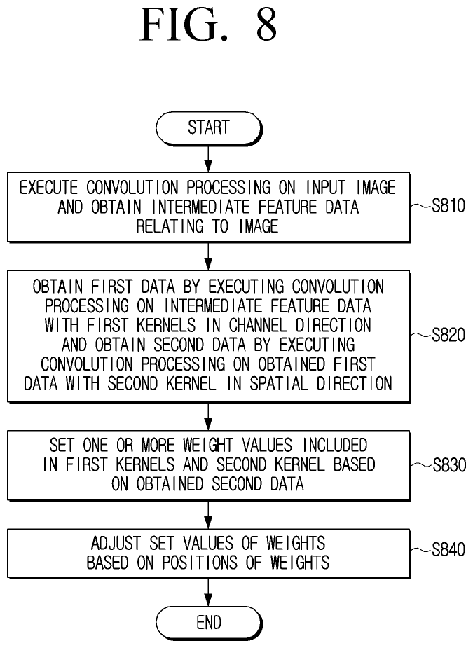

FIG. 8 is a flowchart for describing a method for controlling the electronic device 100 according to an embodiment of the disclosure.

First, the electronic device 100 may execute convolution operation on an input image and obtain intermediate feature data relating to the image (S810). Specifically, the electronic device 100 may extract features by inputting an input image to the CNN, and obtain intermediate feature data based on the extracted features. The obtaining of the intermediate feature data by inputting the input image to the CNN is a well-known technology and thus will be omitted.

The electronic device 100 may obtain first data by executing the convolution operation on the intermediate feature data with first kernels in a channel direction and obtain second data by executing the convolution operation on the obtained first data with a second kernel in a spatial direction (S820). A channel parameter of the first kernels in the channel direction may be identical to a channel parameter of the intermediate feature data. One of a height and a width of each of the first kernels may have a parameter of 1 and the other one thereof may have a parameter of a predetermined integer value other than 1.

The electronic device 100 may set one or more weight values included in the first kernels and the second kernel based on the obtained second data (S830). According to an embodiment of the disclosure, the electronic device 100 may set weight values included in the first kernels and the second kernel using a learning algorithm including error back-propagation or gradient descent.

In addition, the electronic device 100 may compare and analyze the obtained output image and the enlarged input image, and set weight values of each kernel applied to the convolution based on the analyzed result.

The electronic device 100 may adjust set values of the weights based on the positions of the weights (S840). According to an embodiment of the disclosure, the electronic device 100 may execute the normalization to have uniform sums of the weights included in each of the first kernels. In addition, the electronic device 100 may apply (for example, multiplication) a reliability map to the second kernel so that the values of the weights included in the second kernel do not rapidly change. The electronic device 100 may decompose the weights into a plurality of groups and execute normalization to have uniform sums of the weights included in each of the plurality of groups, based on the positions of the weights included in the second kernel.

As described above, according to the embodiments of the disclosure, the electronic device may prevent the generation of checkerboard artifacts, generate a high-quality image when adjusting the size of the image, and decrease the processing amount and a size of a memory, by executing the convolution operation on data relating to an image with a plurality of kernels.

In this disclosure, the term “unit” or “module” may include a unit implemented with hardware, software, or firmware and may be interchangeably used with terms, for example, logic, logic blocks, parts, or circuits. The unit or the module may be a part integrally formed or a minimum unit or a part of the part performing one or more functions. For example, the module may be implemented as an application-specific integrated circuit (ASIC).

Various embodiments of the disclosure may be implemented as software including instructions stored in machine (e.g., computer)-readable storage media. The machine herein is an apparatus which invokes instructions stored in the storage medium and is operated according to the invoked instructions, and may include an electronic device (e.g., electronic device 100) according to the disclosed embodiments. In a case where the instruction is executed by a processor, the processor may execute a function corresponding to the instruction directly or using other elements under the control of the processor. The instruction may include a code generated by a compiler or executed by an interpreter. The machine-readable storage medium may be provided in a form of a non-transitory storage medium. Here, the term “non-transitory” merely mean that the storage medium is tangible while not including signals, and it does not distinguish that data is semi-permanently or temporarily stored in the storage medium. For example, the “non-transitory storage medium” may include a buffer temporarily storing data.

In an embodiment, the methods according to various embodiments of the disclosure may be provided to be included in a computer program product. The computer program product may be exchanged between a seller and a purchaser as a commercially available product. The computer program product may be distributed in the form of a machine-readable storage medium (e.g., compact disc read only memory (CD-ROM) or distributed online through an application store (e.g., PlayStore™). In a case of the on-line distribution, at least a part of the computer program product (for example, a downloadable application) may be temporarily stored or temporarily generated at least in a storage medium such as a memory of a server of a manufacturer, a server of an application store, or a relay server.

Each of the elements (for example, a module or a program) according to various embodiments may be composed of a single entity or a plurality of entities, and some sub-elements of the abovementioned sub-elements may be omitted or other sub-elements may be further included in various embodiments. Alternatively or additionally, some elements (e.g., modules or programs) may be integrated into one entity to perform the same or similar functions performed by each respective element prior to integration. Operations performed by a module, a program, or other elements, in accordance with various embodiments, may be performed sequentially, in a parallel, repetitive, or heuristically manner, or at least some operations may be performed in a different order, omitted, or may add a different operation.

What is claimed is:

1. An electronic device comprising:
a memory for storing at least one instruction; and
a processor configured to execute the at least one instruction,
wherein the processor is configured to execute the at least one instruction to:
execute a first convolution operation on an input image and obtain, as a result of the first convolution operation, intermediate feature data,
obtain first data by executing a second convolution operation on the intermediate feature data with a plurality of first kernels in a channel direction, wherein the plurality of first kernels include first weights,
obtain second data by executing a third convolution operation on the first data with a second kernel in a spatial direction, wherein the second kernel includes second weights,
set, based on the second data, first values of the first weights or set second values of the second weights,
adjust the first values of the first weights based on first positions of the first weights, and
adjust the second values of the second weights based on second positions of the second weights.

2. The electronic device according to claim 1, wherein one of a height and a width of the plurality of first kernels has a first parameter of 1 and another one of the height and the width has a second parameter of a predetermined integer value other than 1,
wherein the processor is further configured to:
normalize the first values of the first weights based on the first positions of the first weights in the plurality of first kernels, and.
normalize the second values of the second weights based on the second positions of the second weights in the second kernel.

3. The electronic device according to claim 2, wherein the processor is further configured to adjust the first values of the first weights to have identical sums in each first kernel of the plurality of first kernels.

4. The electronic device according to claim 1, wherein the processor is further configured to adjust the second values of the second weights by applying a reliability map, including a weight function, to the second kernel.

5. The electronic device according to claim 4, wherein the weight function comprises a function with values gradually changing from a center of the reliability map.

6. The electronic device according to claim 1, wherein the processor is further configured to:
decompose the second weights of the second kernel into a plurality of groups, and
normalize each group of the plurality of groups based on positions of the second weights in the second kernel.

7. The electronic device according to claim 6, wherein the processor is further configured to identify a number of the plurality of groups and numbers of weights included in each group of the plurality of groups based on parameter values of the second kernel and a size of a stride applied by the third convolution operation.

8. The electronic device according to claim 6, wherein the processor is further configured to, for a first group of the plurality of groups, adjust the second values of the second weights to have uniform sums of the second weights included in the first group of the plurality of groups.

9. The electronic device according to claim 6, wherein the processor is further configured to:
obtain the second data by executing the third convolution operation on the first data using the plurality of groups, and
obtain an output image by rearranging the second data.

10. The electronic device according to claim 9, further comprising:
a display,
wherein the processor is further configured to control the display to display the output image, wherein the output image has a first size larger than a second size of the input image.

11. A method for controlling an electronic device, the method comprising:
executing a first convolution operation on an input image and obtaining, as a result of the first convolution operation, intermediate feature data;
obtaining first data by executing a second convolution operation on the intermediate feature data with a plurality of first kernels in a channel direction, wherein the plurality of first kernels include first weights;
obtaining second data by executing a third convolution operation on the first data with a second kernel in a spatial direction, wherein the second kernel includes second weights;
setting, based on the second data, first values of the first weights or second values of the second weights;
adjusting the first values of the first weights based on first positions of the first weights; and
adjusting the second values of the second weights based on second positions of the second weights.

12. The method according to claim 11, wherein one of a height and a width of the plurality of first kernels has a first parameter of 1 and another one of the height and the width has a second parameter of a predetermined integer value other than 1,
wherein the adjusting the first values of the first weights comprises normalizing the plurality of first kernels based on the first positions of the first weights in the plurality of first kernels.

13. The method according to claim 12, wherein the adjusting the first values of the first weights comprises adjusting the first values of the first weights to have identical sums in each first kernel of the plurality of first kernels.

14. The method according to claim 12, wherein the adjusting the second values of the second weights further comprises adjusting the second values of the second weights by applying a reliability map, including a weight function, to the second kernel.

15. The method according to claim 14, wherein the weight function comprises a function with values gradually changing from a center of the reliability map.

16. The method according to claim 11, wherein the adjusting the second values of the second weights further comprises decomposing the second weights into a plurality of groups; and
normalizing each group of the plurality of groups based on positions of the second weights in the second kernel.

17. The method according to claim 16, wherein the adjusting the second values of the second weights further comprises identifying a number of the plurality of groups and numbers of weights included in each group of the plurality of groups based on parameter values of the second kernel and a size of a stride applied by the third convolution operation.

18. The method according to claim 16, wherein the adjusting the second values of the second weights further comprises for a first group of the plurality of groups, adjusting the second values of the second weights to have uniform sums of the second weights included in the first group of the plurality of groups.

19. The method according to claim 16, wherein the obtaining the second data further comprises obtaining the second data by executing the third convolution operation on the first data with the plurality of groups, and the method further comprises obtaining an output image by rearranging the second data.

20. The method according to claim 19, further comprising displaying the output image, wherein the output image has a first size larger than a second size of the input image.
